(19) United States
(12) Patent Application Publication
(10) Pub. No.: US 2023/0337082 A1
(43) Pub. Date: Oct. 19, 2023

(54) CONFIGURATION FOR MEASUREMENT

(71) Applicant: ZTE CORPORATION, Shenzhen (CN)

(72) Inventors: Chenchen ZHANG, Shenzhen (CN); Nan ZHANG, Shenzhen (CN); Wei CAO, Shenzhen (CN); Kaibo TIAN, Shenzhen (CN); Zhen YANG, Shenzhen (CN)

(73) Assignee: ZTE CORPORATION, Shenzhen (CN)

(21) Appl. No.: 18/189,629

(22) Filed: Mar. 24, 2023

Related U.S. Application Data
(63) Continuation of application No. PCT/CN2020/121580, filed on Oct. 16, 2020.

(51) Int. Cl. H04W 36/00

(52) U.S. Cl. CPC H04W 36/0094; H04W 52/0209

(57) ABSTRACT

A wireless communication method for use in a wireless terminal is disclosed. The method comprises receiving, from a wireless network node, a measurement configuration including a beam indication; and receiving at least one reference signal based on the beam indication of the measurement configuration.

This application is a continuation of PCT/CN2020/121580, filed Oct. 16, 2020, the content of which is incorporated herein by reference in its entirety.

### TECHNICAL FIELD

This document is directed generally to wireless communications.

### BACKGROUND

In a wireless communication network, a user equipment (UE) generally needs to periodically measure the link quality of its serving base station (BS) and neighboring BSs for mobility management. In idle mode, the UE may reselect a cell to reside based on the measurement results. In connected mode, the measurement results may be reported to the BS for assisting handover decision making. The configuration for measurement behaviors is indicated from the BS to UE via system information block (SIB) message(s) or dedicated RRC signaling(s).

### SUMMARY

A measurement configuration may contain a periodicity, a duration, a cell list, etc. The reducing of measurement periodicity helps the UEs to timely select the cell with the best quality. However, frequent measurements may cause high power consumption. To achieve a good tradeoff, the BS may indicate the UEs to use different periodicities to measure different neighboring cells. With a longer measurement periodicity for less important cells, the UE is able to save power while ensuring the link quality.

In a non-terrestrial network (NTN), a single cell may consist of several beams. Different beams may locate in different bandwidth parts. Similarly, the reference signals corresponding to different beams are also in different bandwidth parts. The UE needs to turn its radio frequency (RF) to different bandwidth parts to measure one cell, resulting in significant time and power consumptions. Therefore, how to design the configuration of measurements in the NTN becomes a topic to be discussed.

This document relates to methods, systems, and devices related to a new measurement configuration, and more particularly to a new measurement configuration having at least one of a beam level indication or an indication of a plurality of periodicities.

The present disclosure relates to a wireless communication method for use in a wireless terminal. The method comprises:
receiving, from a wireless network node, a measurement configuration including a beam indication; and
receiving at least one reference signal based on the beam indication of the measurement configuration.

Various embodiments may preferably implement the following features:

Preferably, the measurement configuration comprises at least one physical cell indication associated with the beam indication.

Preferably or in some implementations, the at least one reference signal is received by using the beam indication in the at least one physical cell corresponding to the at least one physical cell indication.

Preferably or in some implementations, the measurement configuration comprises at least one periodicity of receiving the at least one reference signal in the at least one physical cell.

Preferably or in some implementations, the measurement configuration is received in at least one of a system information block, an information element in a higher layer signaling or a narrowband internet-of-things system information block.

Preferably or in some implementations, the beam indication comprises at least one of a beam index, a synchronization signal block index, a bandwidth part index, a channel state information reference signal index, a narrow-band internet-of-things system information block index, an anchor carrier index, a non-anchor carrier index or a cell reference signal index.

Preferably or in some implementations, the wireless communication method further comprises measuring the at least one reference signal according to the measurement configuration.

Preferably or in some implementations, the wireless communication method further comprises transmitting, to the wireless network node, at least one measurement result of measuring the at least one reference signal.

The present disclosure relates to a wireless communication method for use in a wireless network node. The method comprises:
transmitting, to a wireless terminal, a measurement configuration including a beam indication; and
transmitting at least one reference signal based on the beam indication of the measurement configuration.

Various embodiments may preferably implement the following features:

Preferably or in some implementations, the measurement configuration comprises at least one physical cell indication associated with the beam indication.

Preferably or in some implementations, the at least one reference signal is received by using the beam indication in the at least one physical cell corresponding to the at least one physical cell indication.

Preferably or in some implementations, the measurement configuration comprises at least one periodicity of receiving the at least one reference signal in the at least one physical cell.

Preferably or in some implementations, the measurement configuration is transmitted in at least one of a system information block, an information element in a higher layer signaling or a narrowband internet-of-things system information block.

Preferably or in some implementations, the measurement configuration is transmitted in a narrowband system information block.

Preferably or in some implementations, the beam indication comprises at least one of a beam index, a synchronization signal block index, a bandwidth part index, a channel state information reference signal index, a system information block narrow-band index, an anchor carrier index, a non-anchor carrier index or a cell reference signal index.

Preferably or in some implementations, the wireless communication method further comprises receiving, from the wireless terminal, at least one measurement results associated with the at least one reference signal.

The present disclosure relates to wireless communication method for use in a wireless terminal. The method comprises:
receiving, from a wireless network node, a measurement configuration including a plurality of periodicities, wherein each of the plurality of periodicities is corresponding to one of a plurality of cells; and
receiving at least one reference signal of each of the plurality of cells based on the corresponding periodicity.

Various embodiments may preferably implement the following feature:

Preferably or in some implementations, the measurement configuration is received in at least one of a system information block, an information element in a higher layer signaling or a narrowband internet-of-things system information block.

Preferably or in some implementations, the measurement configuration is transmitted in a narrowband system information block.

The present disclosure relates to a wireless communication method for use in a wireless network node. The method comprises:
transmitting, to a wireless terminal, a measurement configuration including a plurality of periodicities, wherein each of the plurality of periodicities is corresponding to one of a plurality of cells; and
transmitting at least one reference signal of each of the plurality of cells based on the corresponding periodicity.

Various embodiments may preferably implement the following feature:

Preferably or in some implementations, the measurement configuration is transmitted in at least one of a system information block, an information element in a higher layer signaling or a narrowband internet-of-things system information block.

Preferably or in some implementations, the measurement configuration is transmitted in a narrowband system information block.

The present disclosure relates to a wireless terminal comprising a communication unit configured to:
receive, from a wireless network node, a measurement configuration including a beam indication; and
receive at least one reference signal based on the beam indication of the measurement configuration.

Various embodiments may preferably implement the following feature:

Preferably or in some implementations, the wireless terminal further comprises a processor configured to perform a wireless communication method recited in any one of the foregoing described methods.

The present disclosure relates to a wireless network node, comprising a communication unit configured to:
transmit, to a wireless terminal, a measurement configuration including a beam indication; and
transmit at least one reference signal based on the beam indication of the measurement configuration.

Various embodiments may preferably implement the following feature:

Preferably or in some implementations, the wireless network node further comprises a processor configured to perform a wireless communication method recited in any one of the foregoing described methods.

The present disclosure relates to a terminal, comprising a communication unit configured to:
receive, from a wireless network node, a measurement configuration including a plurality of periodicities, wherein each of the plurality of periodicities is corresponding to one of a plurality of cells; and
receive at least one reference signal of each of the plurality of cells based on the corresponding periodicity.

The present disclosure relates to a wireless network node, comprising a communication unit configured to:
transmit, to a wireless terminal, a measurement configuration including a plurality of periodicities, wherein each of the plurality of periodicities is corresponding to one of a plurality of cells; and
transmit at least one reference signal of each of the plurality of cells based on the corresponding periodicity.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a schematic diagram of a wireless terminal according to an embodiment of the present disclosure.

FIG. 2 shows an example of a schematic diagram of a wireless network node according to an embodiment of the present disclosure.

FIG. 3 shows a schematic diagram of a measurement procedure according to an embodiment of the present disclosure.

FIG. 4 shows a schematic diagram of a cell according to an embodiment of the present disclosure.

FIG. 5 shows a schematic diagram of cells in the non-territory-network according to an embodiment of the present disclosure.

FIG. 6 shows a flowchart of a process according to an embodiment of the present disclosure.

FIG. 7 shows a flowchart of a process according to an embodiment of the present disclosure.

FIG. 8 shows a flowchart of a process according to an embodiment of the present disclosure.

FIG. 9 shows a flowchart of a process according to an embodiment of the present disclosure.

### DETAILED DESCRIPTION

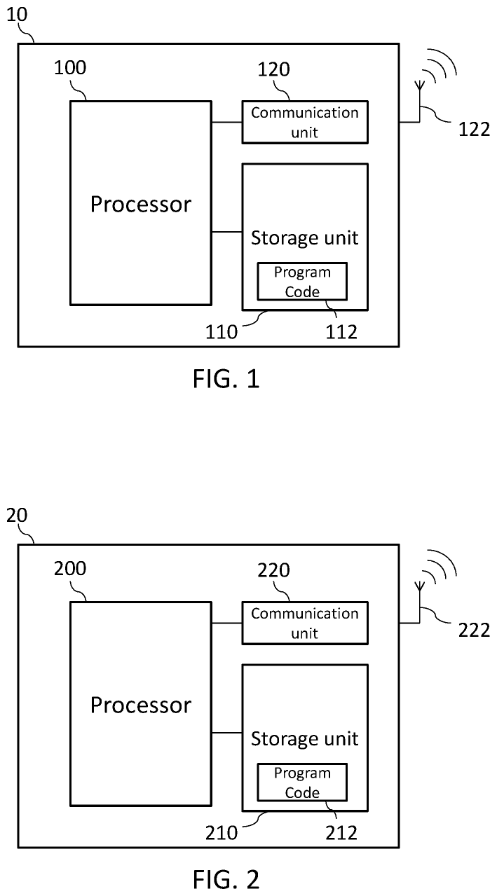

FIG. 1 relates to a schematic diagram of a wireless terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g. messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g. a base station).

FIG. 2 relates to a schematic diagram of a wireless network node 20 according to an embodiment of the present disclosure. The wireless network node 20 may be a satellite, a base station (BS), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g. messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g. a user equipment).

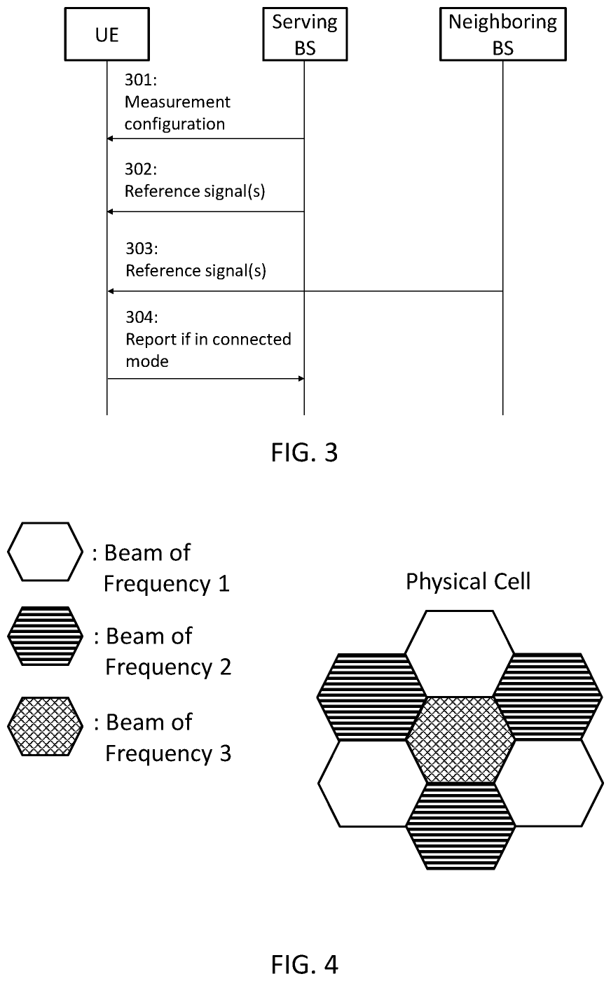

FIG. 3 shows a schematic diagram of a measurement procedure according to an embodiment of the present disclosure. More specifically, in NR (new radio) or LTE (long-term evolution), the measurement configuration is transmitted to UE by SIB (messages) in an idle mode, and by dedicated RRC signaling in a connected mode (step 301). In an embodiment, the configuration is in the cell level. Based on the measurement configuration, the UE measures reference signals transmitted from a serving BS and neighboring BSs (FIG. 3 shows one neighboring BS for illustration). The reference signals may be SSB (Synchronization Signal block or Synchronization Signal and physical broadcast channel (PBCH) block) and/or CSI-RS (channel state information reference signal) (steps 302 and 303). Finally, the UE may decide whether to reside in another BS in the idle mode or report the measurement results to the serving BS in the connected mode (step 304).

According to an embodiment, the measurement configuration for UE in idle mode in NR is illustrated in the following.

A UE in the idle mode needs to periodically perform measurements for cell re-selection. The measurement periodicity is determined based on the SIB transmitted by the BS. In NR, the SIB4 contains information for inter-frequency cell re-selection. In the SIB4, the information elements (IEs) SSB-MTC and SSB-MTC2-LP-r16 give measurement periodicities on the SSB. After the UE decodes the SIB, the UE may choose different measurement periodicities for different cells. According to an embodiment, the two IEs SSB-MTC and SSB-MTC2-LP-r16 are as follows:

Embodiment of IE SSB-MTC:

```
SSB-MTC ::= SEQUENCE {
    periodicityAndOffset CHOICE {
        sf5 INTEGER (0..4),
        sf10 INTEGER (0..9),
        sf20 INTEGER (0..19),
        sf40 INTEGER (0..39),
        sf80 INTEGER (0..79),
        sf160 INTEGER (0..159)
    },
    duration ENUMERATED { sf1, sf2, sf3, sf4, sf5 }
}
```

Embodiment of IE SSB-MTC2-LP-r16:

```
SSB-MTC2-LP-r16 ::= SEQUENCE {
    pci-List SEQUENCE (SIZE
(1..maxNrofPCIsPerSMTC)) OF PhysCellId OPTIONAL,  -- Need
R
    periodicity ENUMERATED {sf10, sf20, sf40, sf80, sf160,
spare3, spare2, spare1}
}
```

According to an embodiment, the measurement configuration in idle mode in NB-IoT (narrow-band internet-of-things) is illustrated as follows.

In the NB-IoT, the inter-frequency measurement of the UE in idle mode is configured by the IE SystemInformationBlockType5-NB (i.e. SIB5-NB). The configuration is in cell level and the measured neighboring cell identities are contained in the interFreqNeighCellList of the IE SIB5-NB.

FIG. 4 shows a schematic of the physical cell in NTN according to an embodiment of the present disclosure. More specifically, in NTN, a physical cell contains one or more beams and the one or more beams may have different frequencies for mitigating interferences. In FIG. 4, each pattern denotes a frequency. In NR over NTN, the frequency reuse may be realized by using different bandwidth parts (BWPs) as beams. In NB-IoT over NTN, the frequency reuse can be realized by using different carriers as beams.

### Embodiment 1: Measurement Configuration in NR-NTN

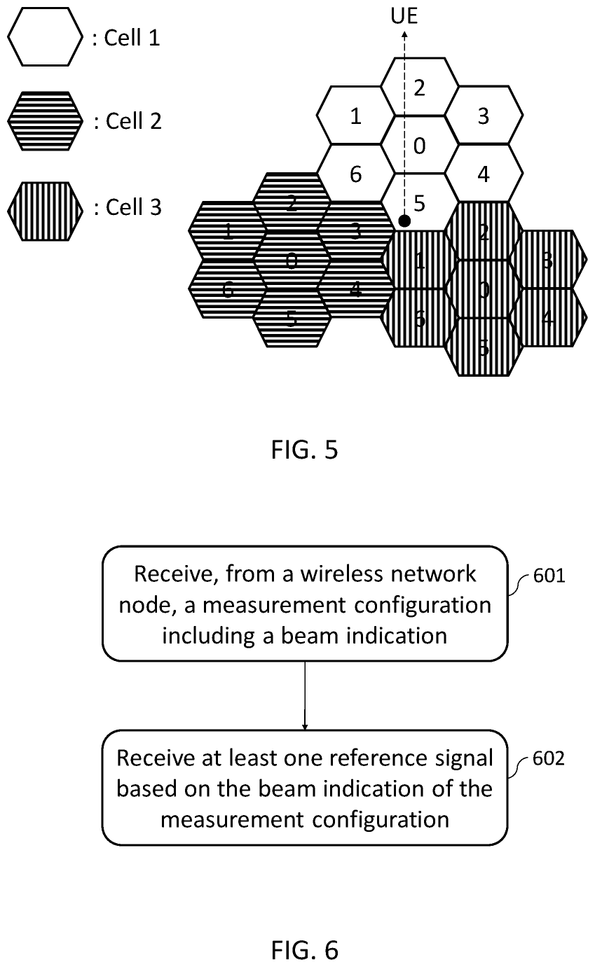

The measurement configuration in terrestrial NR is in cell level. That is, each configuration IE is applied to a physical cell or a list of physical cells. In the NTN (e.g. NR-NTN), different beams may be in different bandwidth parts and each of the beams has a large geographical size and may have different requirements for measurements. FIG. 5 shows a schematic diagram of cells in the NTN according to an embodiment of the present disclosure. In FIG. 5, a UE in a beam edge of beam 5 (e.g. a beam with an index 5) of cell 1 (i.e. the cell with an index 1) may try to find a new cell to reside. According to an embodiment, the signal quality (e.g. intensity) of beam 6 in cell 2 and beam 4 in cell 3 may be too weak for the UE. Under such conditions, the UE may not need to measure reference signals corresponding to these two beams (i.e. beam 6 in cell 2 and beam 4 in cell 3). That is, if the BS configures the UE not to measure (e.g. receive) the reference signals corresponding to the beam 6 in cell 2 and beam 4 in cell 3, the power consumption may be decreased. Thus, in the present disclosure, a beam level measurement configuration is introduced to provide more flexible measurement configuration and to improve network efficiency.

In the present disclosure, a beam may be denoted by at least one of
Reference signal index
Reference signal association, e.g., Quasi Co-location
Polarization pattern

Resource index: resource including frequency domain resource such as bandwidth part, carrier(s); time domain resource such as slot; spatial domain resource such as antenna port, transport layer, codebook; CDM group such as DM-RS.

Logic index: defined by association between some implementation based arrangement and beam. The mapping between the logic index and location can be fixed. For example, the logic index can be area index, cell index, or tracking area ID.

In the present disclosure, “physical cell” may be equal to “cell”.

### Embodiment 1-1: Beam-Level Configuration in Idle Mode

In this embodiment, the BS may indicate beam(s) and/or beam index(es) in the SIB to the UE in the idle mode. In an embodiment, each beam index may be associated with physical cell(s) and/or physical cell index(es). By indicating the beam and/or beam index in the SIB associating the physical cell index, the BS is able to configure the UE in the idle mode to perform measurement(s) in beam level. In an embodiment, the beam and/or beam index may be determined by the SSB index and the indication of SSB index in SIB. That is, the beam level configuration may be achieved by transmitting the corresponding SSB index(es) and/or the indication(s) of the SSB index(es). As an alternative or in addition, the beam(s) and/or beam index(es) may be indicated by a bandwidth part (BWS) index and/or a channel state information reference signal (CSI-RS) index.

The signaling indicating the beam(s) and/or beam index(es) is exemplified as the following:

(1) The BS indicates a physical cell index list and a beam index list to the UE in SIB, wherein the physical cell index list and the beam index list are associated with a list of beams.

According to an embodiment, the IE SMTC2 can be set as follows.

SSB-MTC2-LP-r16 ::= SEQUENCE {
pci-List SEQUENCE (SIZE (1..maxNrofPCIsPerSMTC))
OF PhysCellId OPTIONAL, -- Need R
beam-List SEQUENCE (SIZE (1..maxNrofPCIsPerSMTC))
OF BeamId OPTIONAL, -- Need R
periodicity ENUMERATED {sf10, sf20, sf40, sf80, sf160,
spare3, spare2, spare1}
}

Note that the aforementioned IE SMTC2 comprises IE beam-List for indicating a list of beam.

In an embodiment, the BeamId (e.g. beam index) in the IE beam-List of the IE SMTC2 may be replaced by SSB index, BWP index or CSI-RS index.

(2) The BS indicates a physical cell index list and an SSB index list to UE in SIB, wherein the physical cell index list and the SSB index list are associated with a list of beams.

(3) The BS indicates a physical cell index list and a BWP index list to UE in SIB, wherein the physical cell index list and the BWP index list are associated with a list of beams.

(4) The BS indicates a physical cell index list and a CSI-RS index list to UE in SIB, wherein the physical cell index list and the CSI-RS index list are associated with a list of beams.

(5) The BS indicates a list of IEs to UE in SIB, wherein each IE denotes the combination of a physical cell index with a beam index, an SSB index, a BWP index or a CSI-RS index.

According to an embodiment, the IE SMTC2 can be set as the following:

SSB-MTC2-LP-r16 ::= SEQUENCE {
pciAndBeam-List SEQUENCE (SIZE
(1..maxNrofPCIsPerSMTC)) OF PhysCellIdAndBeamId OPTIONAL, -
- Need R
periodicity ENUMERATED {sf10, sf20, sf40, sf80, sf160,
spare3, spare2, spare1}
}
PhysCellIdAndBeamId ::= SEQUENCE {
PhysCellId,
BeamId
}

In this embodiment, the IE pciAndBeam-List is used to replace the IE pci-List.

In an embodiment, the BeamId the IE pciAndBeam-List may be replaced by SSB index, BWP index or CSI-RS index.

### Embodiment 1-2: Beam-Level Configuration in Connected Mode

In this embodiment, the BS may indicate beam(s) and/or beam index(es) in a higher layer signaling (e.g. radio resource control (RRC) signaling) associated with a physical cell index, e.g., in an IE measObject. By indicating the beam(s) and/or beam index(es) in the higher layer signaling associating the physical cell index in the IE measObject, the BS is able to configure UEs of the connected mode to perform measurements in the beam level. In an embodiment, the beam index may be determined by the SSB index. Thus, the beam level configuration may also be achieved by indicating the SSB index(es) in the SIB. The signaling of indicating the beam(s) and/or beam index(es) is exemplified as the following:

(1) The BS indicates a physical cell index list and a beam index list to UE in the IE measObject, wherein the beam index list indicates a list of beams.

According to an embodiment, the IE SMTC2 may be set as the following:

SSB-MTC2 ::= SEQUENCE {
pci-List SEQUENCE (SIZE (1..maxNrofPCIsPerSMTC))
OF PhysCellId OPTIONAL, -- Need M
beam-List SEQUENCE (SIZE (1..maxNrofPCIsPerSMTC))
OF BeamId OPTIONAL, -- Need M
periodicity ENUMERATED {sf5, sf10, sf20, sf40, sf80,
spare3, spare2, spare1}
}

In this embodiment, the IE SMTC2 comprises IE beam-List.

Note that, the BeamId (e.g. beam index) in the IE beam-List of the IE SMTC2 may be replaced by SSB index, BWP index or CSI-RS index.

(2) The BS indicates a physical cell index list and an SSB index list to UE in the IE measObject, wherein the physical cell index list and the SSB index list are associated with a list of beams.

(3) The BS indicates a physical cell index list and a BWP index list to UE in measObject, wherein the physical cell index list and the BWP indicates list are associated with a list of beams.

(4) The BS indicates a physical cell index list and a CSI-RS index list to UE in measObject, wherein the physical cell index list and the CSI-RS index list are associated with a list of beams.

(5) The BS indicates a list of IEs to UE in measObject, in which each IE denotes the combination of a physical cell index and a beam index, an SSB index, a BWP index or a CSI-RS index.

According to an embodiment, the IE SMTC2 can be set as follows:

SSB-MTC2 ::= SEQUENCE {
pciAndBeam-List SEQUENCE (SIZE
(1..maxNrofPCIsPerSMTC)) OF PhysCellIdAndBeamId OPTIONAL, -
- Need M
periodicity ENUMERATED {sf5, sf10, sf20, sf40, sf80,
spare3, spare2, spare1}
}
PhysCellIdAndBeamId ::= SEQUENCE {
PhysCellId,
BeamId
}

In this embodiment, the IE pciAndBeam-List is used to replace the IE pci-List.

In an embodiment, the BeamId in the IE pciAndBeam-List may be replaced by the SSB index, BWP index or CSI-RS index.

### Embodiment 1-3: Flexible Configuration for Measurement Periodicity of Cells

In NR, each IE SMTC2 only contains one periodicity. A BS needs to transmit more than one SMTC2 or measObject to configure different measurement periodicities for different cells. In an embodiment of the present disclosure, one IE SMTC2 may contain more than one periodicity and the measurement configuration can be more flexible and signaling overhead can be saved.

In an embodiment, the BS indicates a list of periodicity (i.e. a plurality of periodicities or more than one periodicity) to the UE(s) in the IE SMTC2, wherein the list of periodicity may be associated with the cell list (e.g. a plurality of cells). As a result, the UE is able to use different periodicities to perform measurements (e.g. receiving reference signals associated with the measurements) for different cells.

According to an embodiment, the IE SMTC2 may be set as the following:

SSB-MTC2 ::= SEQUENCE {
pci-List SEQUENCE (SIZE (1..maxNrofPCIsPerSMTC))
OF PhysCellId OPTIONAL, -- Need M
periodicity-List SEQUENCE (SIZE
(1..maxNrofPCIsPerSMTC)) OF periodicity, OPTIONAL, -- Need M
}
periodicity ::= ENUMERATED {sf5, sf10, sf20, sf40, sf80, spare3,
spare2, spare1}

In this embodiment, the IE periodicity-List is used to replace the IE periodicity.

In an embodiment, the IE pci-List may be replaced by the aforementioned IE pciAndBeam-List.

### Embodiment 2: Measurement Configuration in NB-IoT-NTN

In the NB-IoT, the inter-frequency measurement behavior for idle UE (i.e. the UE in idle mode) is configured in the SIB5-NB. The IE interFreqNeighCellList is associated with the IE nsss-RRM-Config and some other IEs to define the measurement configuration in different physical cells.

### Embodiment 2-1: Beam-Level Configuration for NB-IoT-NTN

Similar with the NR-NTN, if the NB-IoT UE is supported by the NTN, a beam level configuration also improves the flexibility of measurements. According to an embodiment, the signaling associated with the beam level configuration may be set as the following:

(1) The BS indicates a physical cell index list and a beam index list to the UE in the NB-IoT SIB, which are associated to a list of beams. According to an embodiment, a new IE beam-List associated with the IE InterFreqNeighCellList can be set as the following:

InterFreqNeighCellList-NB-r13 ::= SEQUENCE (SIZE (1..maxCellInter)) OF
PhysCellId
beam-List ::= SEQUENCE (SIZE (1..maxCellInter))
OF BeamId OPTIONAL, -- Need M

In this embodiment, the IE beam-List is added into the NB IOT-SIB.

In an embodiment, the BeamId in the IE beam-List may be replaced by anchor/non-anchor carrier index or CRS (cell-specific reference signal) index.

(2) The BS indicates a physical cell index list and an anchor/non-anchor carrier index list to the UE in the NB IOT-SIB, wherein the physical cell index list and the anchor/non-anchor carrier index list are associated with a list of beams.

(3) The BS indicates a physical cell index list and a CRS index list to UE in NB IOT-SIB, wherein the physical cell index list and the CRS index list are associated with are associated to denote a list of beams.

(4) The BS indicates a list of IEs to UE in NB IOT-SIB, in which each IE denote the combination of a physical cell index and a beam index, an anchor/non-anchor carrier index, or a CRS index. According to an embodiment, a new IE InterFreqNeighCellAndBeamList may be set as the following:

InterFreqNeighCellAndBeamList ::= SEQUENCE (SIZE (1..maxCellInter)) OF
PhysCellAndBeamId
PhysCellIdAndBeamId ::= SEQUENCE {
PhysCellId,
BeamId
}

In an embodiment, the new IE InterFreqNeighCellAndBeamList is used to replace the IE InterFreqNeighCellList-NB-r13 in the NB IOT-SIB.

In this disclosure, a method is proposed to achieve the beam level measurement configuration and/or a measurement configuration having multiple periodicities corresponding to multiple cells. According to an embodiment, the characteristics of the proposed method at least include:

(1) One or more beam indexes associating with the physical cell index are indicated in measurement configuration in SIB. The SIB can be beam-specific or cell-specific. If the SIB is cell-specific, a beam index is also indicated to denote the applied beam of this configuration. The beam index can be replaced by another index which implicitly determines the beam index, such as SSB index, BWP index and CSI-RS index.

(2) One or more beam indexes associating with physical cell index are indicated in the IE MeasObjectNR in the RRC signaling.

The beam index can be replaced by another index which can implicitly determine the beam index, such as SSB index, BWP index and/or CSI-RS index.

(3) One or more beam indexes associated with physical cell index are indicated in measurement configuration in NB IOT-SIB. The NB IOT-SIB can be beam-specific or cell-specific. If the SIB is cell-specific, a beam index is also indicated to denote the applied beam of this configuration. The beam index can be replaced by another index which implicitly determines the beam index, such as anchor/non-anchor carrier index and CRS index.

(4) A list of periodicity (e.g. a plurality of periodicities) associated with the physical cell index list is indicated in measurement configuration in SIB, to allow the UE to use different periodicities to measure different cells.

FIG. 6 shows a flowchart of a process according to an embodiment of the present disclosure. The process shown in FIG. 6 may be used in a wireless terminal (e.g. UE) and comprises the following steps:

Step 601: Receive, from a wireless network node, a measurement configuration Including a beam indication.

Step 602: Receive at least one reference signal based on the beam indication of the measurement configuration.

In FIG. 6, the wireless terminal receives a measurement configuration from a wireless network node (e.g. BS). In this embodiment, the measurement configuration comprises (or includes) a beam indication (e.g. a list of beams), e.g. associated with at least one beam. Based on the measurement configuration, the wireless terminal receives at least one reference signal, e.g., from the wireless network node. As a result, the wireless terminal is able to receive the reference signal and perform measurement in the beam level.

In an embodiment, the measurement configuration comprises at least one physical cell indication associated with the beam indication.

In an embodiment, the at least one reference signal is received by using (e.g. based on) the beam indication in the at least one physical cell corresponding to the at least one physical cell indication.

In an embodiment, the measurement configuration is received in at least one of a SIB (message), an IE in a higher layer signaling or a NB-IoT SIB.

In an embodiment, the NB-IoT SIB may be equal to NB SIB.

In an embodiment, the measurement configuration comprises at least one periodicity (e.g. more than one periodicity) of receiving the at least one reference signal in the at least one physical cell. That is, the wireless terminal may use different periods (e.g. frequencies) to receive the reference signal(s) in different cells.

In an embodiment, the beam indication comprises at least one of a beam index, a synchronization signal block index, a bandwidth part index, a channel state information reference signal index, a narrow-band internet-of-things system information block index, an anchor carrier index, a non-anchor carrier index or a cell reference signal index.

In an embodiment, the wireless terminal may measure the at least one reference signal according to the measurement configuration. That is, the wireless terminal performs the measurement in the beam level.

In an embodiment, the wireless terminal may transmit (e.g. report) at least one measurement result of measuring the at least one reference signal.

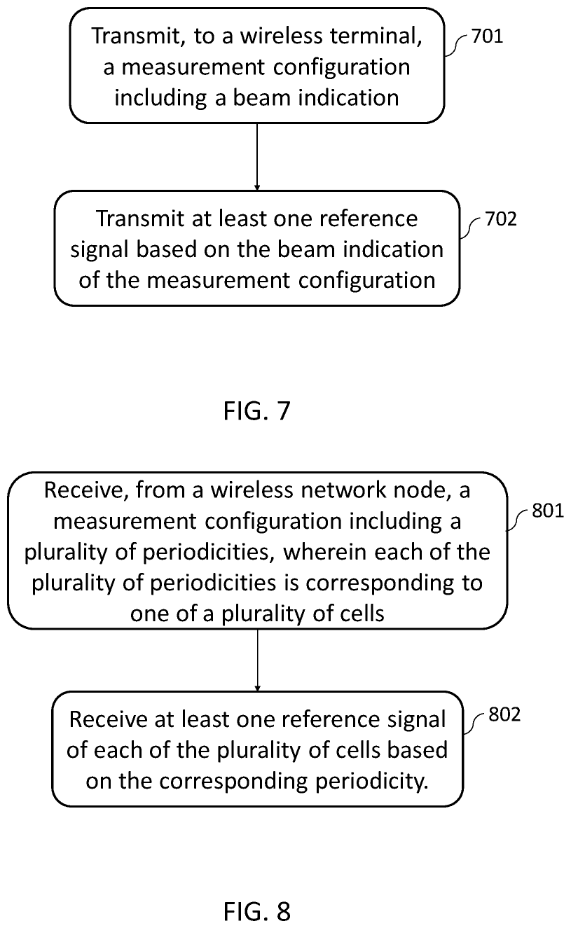

FIG. 7 shows a flowchart of a process according to an embodiment of the present disclosure. The process shown in FIG. 7 may be used in a wireless network node (e.g. BS) and comprises the following steps:

Step 701: Transmit, to a wireless terminal, a measurement configuration including a beam indication.

Step 702: Transmit at least one reference signal based on the beam indication of the measurement configuration.

More specifically, the wireless network node transmits a measurement configured to a wireless terminal (e.g. UE) In this embodiment, the measurement configuration comprises (or includes) a beam indication (e.g. a list of beams). Based on the measurement configuration, the wireless network node transmits at least one reference signal, e.g., to the wireless terminal.

In an embodiment, the measurement configuration comprises at least one physical cell indication (e.g. a list of physical cells) associated with the beam indication.

In an embodiment, the at least one reference signal is transmitted by using (e.g. based on) the beam indication in the at least one physical cell corresponding to the at least one physical cell indication.

In an embodiment, the measurement configuration comprises at least one periodicity (e.g. more than one periodicity) of receiving the at least one reference signal in the at least one physical cell. That is, the wireless network node may use different periods (e.g. frequencies) to transmit the reference signal(s) in different cells.

In an embodiment, the measurement configuration is transmitted in at least one of a SIB (message), an IE in a higher layer signaling or a NB-IoT SIB.

In an embodiment, the NB-IoT SIB may be equal to NB SIB.

In an embodiment, the beam indication comprises at least one of a beam index, a synchronization signal block index, a bandwidth part index, a channel state information reference signal index, a narrow-band internet-of-things system information block index, an anchor carrier index, a non-anchor carrier index or a cell reference signal index.

In an embodiment, the wireless terminal may receive at least one measurement result of measuring the at least one reference signal.

FIG. 8 shows a flowchart of a process according to an embodiment of the present disclosure. The process shown in FIG. 8 may be used in a wireless terminal (e.g. UE) and comprises the following steps:

Step 801: Receive, from a wireless network node, a measurement configuration including a plurality of periodicities, wherein each of the plurality of periodicities is corresponding to one of a plurality of cells.

Step 802: Receive at least one reference signal of each of the plurality of cells based on the corresponding periodicity.

In the process shown in FIG. 8, the wireless terminal receives a measurement configuration from a wireless network node (e.g. BS). In this embodiment, this measurement configuration comprises a plurality of periodicities and each of the plurality of periodicities is corresponding to (e.g. associated with) one of a plurality of cells. Based on the measurement configuration, the wireless terminal receives at least one reference signal of each cells based on the corresponding periodicity. Because the measurement configuration comprises the plurality of periodicities, the wireless terminal is able to use different periodicities to receive reference signal(s) of different cells via a reduced signal overhead.

In an embodiment, the measurement configuration is received in at least one of a system information block, an information element in a higher layer signaling or a narrowband internet-of-things system information block.

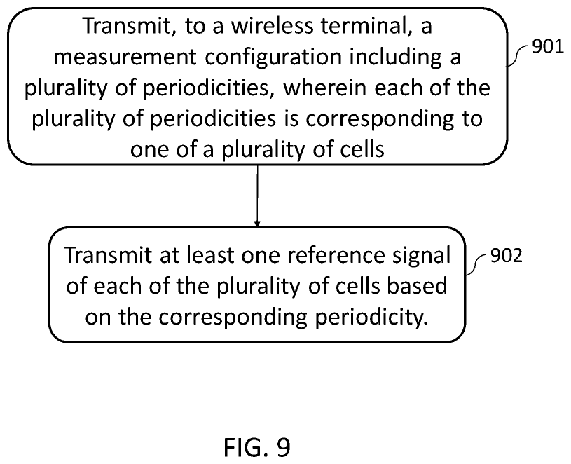

FIG. 9 shows a flowchart of a process according to an embodiment of the present disclosure. The process shown in FIG. 9 may be used in a wireless network node and comprises the following steps:

Step 901: Transmit, to a wireless terminal, a measurement configuration including a plurality of periodicities, wherein each of the plurality of periodicities is corresponding to one of a plurality of cells.

Step 902: Transmit at least one reference signal of each of the plurality of cells based on the corresponding periodicity.

In detail, the wireless network node transmits a measurement configured to a wireless terminal (e.g. UE). In this embodiment, this measurement configuration comprises a plurality of periodicities and each of the plurality of periodicities is corresponding to (e.g. associated with) one of a plurality of cells. Based on the measurement configuration, the wireless network node transmits at least one reference signal of each cells based on the corresponding periodicity.

In an embodiment, the measurement configuration is transmitted in at least one of a SIB (message), an IE in a higher layer signaling or a NB-IoT SIB.

In an embodiment, the NB-IoT SIB may be equal to NB SIB.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
receiving, from a wireless network node, a measurement configuration including a beam indication; and
receiving at least one reference signal based on the beam indication of the measurement configuration.

2. The wireless communication method of claim 1, wherein the measurement configuration comprises at least one physical cell indication associated with the beam indication.

3. The wireless communication method of claim 2, wherein the at least one reference signal is received by using the beam indication in the at least one physical cell corresponding to the at least one physical cell indication.

4. The wireless communication method of claim 2, wherein the measurement configuration comprises at least one periodicity of receiving the at least one reference signal in the at least one physical cell.

5. The wireless communication method of claim 1, wherein the measurement configuration is received in at least one of a system information block, an information element in a higher layer signaling or a narrowband internet-of-things system information block.

6. The wireless communication method of claim 1, wherein the beam indication comprises at least one of a beam index, a synchronization signal block index, a bandwidth part index, a channel state information reference signal index, a narrow-band internet-of-things system information block index, an anchor carrier index, a non-anchor carrier index or a cell reference signal index.

7. The wireless communication of claim 1, further comprising:
measuring the at least one reference signal according to the measurement configuration.

8. The wireless communication of claim 7, further comprising:
transmitting, to the wireless network node, at least one measurement result of measuring the at least one reference signal.

9. A wireless communication method for use in a wireless network node, the method comprising:
transmitting, to a wireless terminal, a measurement configuration including a beam indication; and
transmitting at least one reference signal based on the beam indication of the measurement configuration.

10. The wireless communication method of claim 9, wherein the measurement configuration comprises at least one physical cell indication associated with the beam indication.

11. The wireless communication method of claim 10, wherein the at least one reference signal is received by using the beam indication in the at least one physical cell corresponding to the at least one physical cell indication.

12. The wireless communication method of claim 10, wherein the measurement configuration comprises at least one periodicity of receiving the at least one reference signal in the at least one physical cell.

13. The wireless communication method of claim 9, wherein the measurement configuration is transmitted in at least one of a system information block, an information element in a higher layer signaling or a narrowband internet-of-things system information block.

14. The wireless communication method of claim 9, wherein the beam indication comprises at least one of a beam index, a synchronization signal block index, a bandwidth part index, a channel state information reference signal index, a system information block narrow-band index, an anchor carrier index, a non-anchor carrier index or a cell reference signal index.

15. The wireless communication of claim 9, further comprising:
receiving, from the wireless terminal, at least one measurement results associated with the at least one reference signal.

16. A wireless terminal, comprising:
at least one processor, and
a memory, which is configured to store at least one program;
wherein the at least one program, when executed by the at least one processor, enables the at least one processor to:
receive, from a wireless network node, a measurement configuration including a beam indication; and
receive at least one reference signal based on the beam indication of the measurement configuration.

17. The wireless terminal of claim 16, wherein the measurement configuration comprises at least one physical cell indication associated with the beam indication.

18. A wireless network node, comprising:
at least one processor, and
a memory, which is configured to store at least one program;
wherein the at least one program, when executed by the at least one processor, enables the at least one processor to:
transmit, to a wireless terminal, a measurement configuration including a beam indication; and
transmit at least one reference signal based on the beam indication of the measurement configuration.

19. The wireless network node of claim 18, wherein the measurement configuration comprises at least one physical cell indication associated with the beam indication.
